(19) United States
(12) Patent Application Publication
(10) Pub. No.: US 2011/0211911 A1
(43) Pub. Date: Sep. 1, 2011

(54) METHOD AND APPARATUS FOR ENHANCING MULTIPHASE EXTRACTION OF CONTAMINANTS

(75) Inventors: Andre Michael Masse, Edmonton (CA); Patrick Moss Hicks, Raleigh, NC (US); Brett Charles Davidson, Cambridge (CA)

(73) Assignee: Wavefront Technology Solutions Inc., Edmonton (CA)

(21) Appl. No.: 13/037,810

(22) Filed: Mar. 1, 2011

Related U.S. Application Data
(60) Provisional application No. 61/282,567, filed on Mar. 1, 2010.

(51) Int. Cl. B08B 5/00

(52) U.S. Cl. 405/128.2

(57) ABSTRACT

A method is taught for applying vacuum pulses to enhance multiphase vacuum extraction of vapours and liquids from contaminated subsurface wells. The method involves first initiating continuous multiphase vacuum extraction from the subsurface well. Then one or more short vacuum pulses are imparted to the subsurface environment, to momentarily interrupt flow of vapours and liquids in the subsurface well. Time is allowed for a vacuum to build up in the extraction apparatus; and then the vacuum build up is rapidly released to momentarily increase velocity of vapours and liquids being extracted from the subsurface well. A device is further taught for imparting vacuum pulses to enhance multiphase extraction from contaminated subsurface wells, comprising a vacuum pulse tool having an inlet in fluid communication with the subsurface well and an outlet and one or more multiphase extraction vacuum pumps, connected to the outlet of the vacuum pulse tool.

### RELATED APPLICATIONS

This application claims priority on U.S. patent application Ser. No. 61/282,567 filed Mar. 1, 2010.

### TECHNICAL FIELD

The present invention relates to a method and apparatus for enhancing multiphase extraction of vapours and liquids from contaminated wells.

### BACKGROUND OF THE INVENTION

Multiphase extraction (MPE) is a generic term describing technology used in the environmental industry in which a vacuum is applied to a recovery well and used to extract vapour and liquids simultaneously from the subsurface environment. The liquids may be both water and/or non-aqueous phase liquids (NAPL). MPE technology is often applied at sites contaminated with volatile organic compounds (VOCs) since the contaminants are often entrained in both vapour and liquid matrices being removed from the subsurface environment. Contaminant mass removal processes via MPE include volatilization, advective transport and dissolution.

Other terms used in the environmental remediation industry to describe MPE include Dual Phase Extraction (DPE), Vacuum Enhanced Recovery (VER), Aggressive Fluid Vapour Recovery (AFVR), Mobile Enhanced Multi-Phase Extraction (MEME) or bioslurping. The differences between types of MPE processes lie primarily in the equipment used to apply the vacuum, the level of vacuum induced in the subsurface, fluid extraction rates and the configuration of the extraction well and stinger pipe, if one is used.

The goal of MPE is to maximize the removal of contaminant mass from the subsurface environment. The contaminant mass is entrained in the vapours and liquids removed from the subsurface environment during an MPE event. The flow rates of both vapours and liquids from the subsurface environment to the extraction well are enhanced due to the increased pressure gradient applied to the system by the vacuum, in a similar manner to known injection technologies in the art.

Although increases in fluid recovery rates have been reported with MPE, the remedial progress exhibits asymptotic behaviour over time. The rates of NAPL and groundwater recovery and contaminant concentration in soil vapour decline under continuous operation, and the overall mass removal rate generally drops over a continuous MPE operational period.

Pulsing of MPE systems has been used in the environmental remediation industry for many years in efforts to increase efficiency once asymptotic levels of recovery are reached under continuous operational modes. However, pulsing involves the periodic shutdown and start-up of extraction equipment, which can last anywhere from 30 minutes to several hours, to allow the subsurface to re-equilibrate between active extractions. The periodic starting and stopping greatly decreases operational efficiency and typically presents problems for the technicians attempting to maintain the MPE equipment. Pulsed operation also is considered to be less efficient than operating at low, sustained extraction rates.

An efficient, effective method of enhancing MPE operation is therefore still highly sought in the field.

### SUMMARY OF INVENTION

The present invention provides a method for applying vacuum pulses to enhance multiphase vacuum extraction of vapours and liquids from contaminated subsurface wells. The method comprises first initiating continuous multiphase vacuum extraction from the subsurface well. Then one or more short vacuum pulses are imparted to the subsurface environment to momentarily interrupt flow of vapours and liquids in the subsurface well. Time is allowed for a vacuum to build up in the extraction apparatus; and then the vacuum build up is rapidly released to momentarily increase velocity of vapours and liquids being extracted from the subsurface well.

The present invention further provides a device for imparting vacuum pulses to enhance multiphase extraction from contaminated subsurface wells, comprising a vacuum pulse tool having an inlet in fluid communication with the subsurface well and an outlet and one or more multiphase extraction vacuum pumps, connected to the outlet of the vacuum pulse tool.

### BRIEF DESCRIPTION OF THE DRAWINGS

The embodiments of the present invention will now be described by reference to the following figures, in which identical reference numerals in different figures indicate identical elements and in which:

FIG. 1 is a cross sectional diagram showing various zones of a subsurface formation;

FIG. 2 is a schematic diagram illustrating one embodiment of equipment configuration and operation of the present invention; and

FIG. 3 is a flow diagram illustrating one embodiment of the method of the present invention.

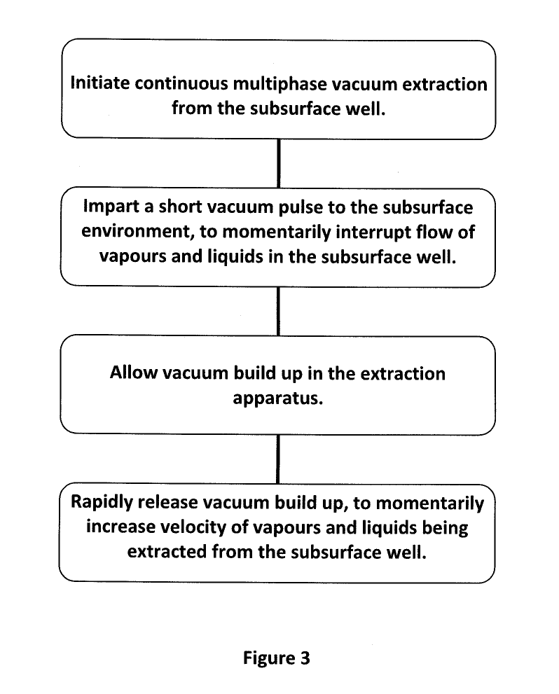

### DETAILED DESCRIPTION OF THE INVENTION

The present invention provides a method and means for the application of vacuum pulses to traditional MPE operations to enhance removal of both vapours and liquids from contaminated subsurface wells.

The inventors have previously successfully applied pressure pulse technology to effectively enhance injection of fluids to support in situ environmental remediation of contaminated aquifers. Pressure pulse technology such as inventors' own Primawave®, induces a pressure pulse in fluids being injected into the well by building up pressure from the injection pump for brief moments and then releasing the pressure, thereby increasing the velocity of the fluids being introduced into the aquifer through an injection well or point. The extra energy enables the fluid to move through pore openings in the aquifer that were not previously accessible through injection alone. The end result is greater injection efficiency and enhanced distribution of the injected fluid throughout the targeted portion of the aquifer.

Through extensive investigation, the inventors have now developed a vacuum pulse technology that can effectively be used to increase the efficacy of traditional MPE operations in the extraction of both vapours and liquids from contaminated subsurface wells.

In the vapour phase, the present vacuum pulse technology increases contaminant mass removal by imparting short vacuum pulses to the subsurface environment. The momentary interruption of vapour phase flow in the subsurface allows for vacuum to build up in the extraction apparatus, and then quickly be released causing a momentary increase in the velocity of vapours being removed from the subsurface. Applying a pulsed vacuum on the subsurface produces similar effects to those noted in pulsing MPE equipment by frequent and repeated shutdowns and start-ups. The removal efficiency and efficacy of vapours is greatly increased compared to continuous operation.

In the liquid phase, the present vacuum pulse technology increases the total liquid flow rate from the extraction well under vacuum, in a similar manner to that routinely observed for injection wells. The present vacuum pulse technology increases groundwater recovery rates when compared with conventional MPE processes because pulsing the vacuum imparts greater energy to the water being entrained, allowing some pores to drain that otherwise would not under laminar vacuum flow.

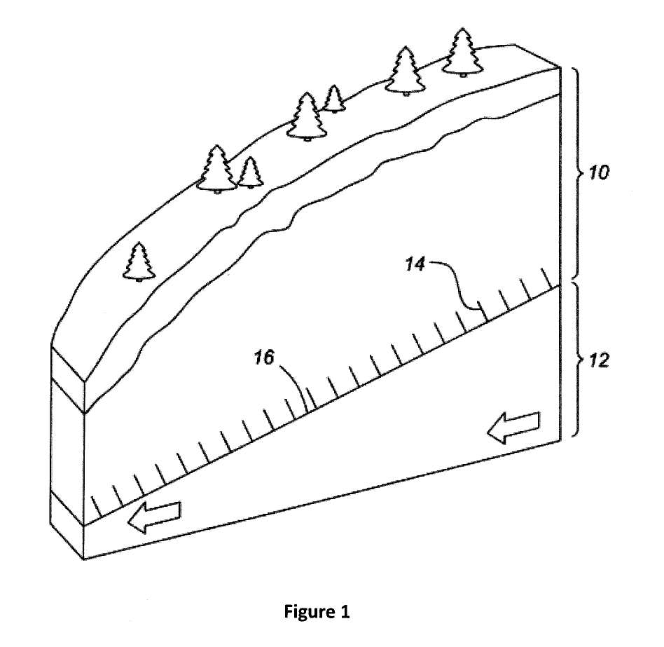

The present technology further increases NAPL recovery via MPE processes, by imparting more energy to the system and thus enhancing the vacuum effect into portions of the NAPL mass that cannot otherwise be influenced under traditional MPE operation. In addition, the pulsing avoids continuous occlusion of NAPL by entrained water rising through the capillary fringe, effectively insulating the NAPL from the extraction process. The temporary reduction in NAPL recovery that occurs due to groundwater elevation increase adjacent to the extraction well under vacuum is reduced by pulsing. This effect is applicable primarily to light non-aqueous phase liquids (LNAPL). With reference to FIG. 1, LNAPL are primarily found in the capillary fringe 14 and smear zone at the interface 16 of the aquifer 12 and the vadose zone 10.

The inclusion of the present vacuum pulse technology with traditional MPE is also applicable to dense non-aqueous phase liquids (DNAPL) which are typically found lower in the aquifer 12 at a lithologic discontinuity. The rate of DNAPL recovery with vacuum pulse technology enhanced MPE depends on the site-specific lithology, and relative depth of the DNAPL in the aquifer 12.

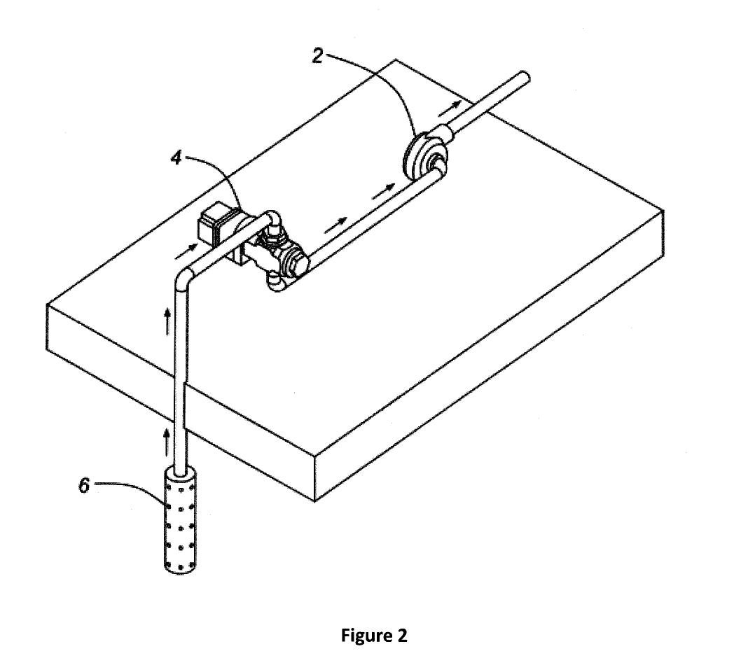

FIG. 2 illustrates one embodiment of the configuration of the present vacuum pulse technology with a traditional MPE system. It will be understood to a person skilled in the art that any number of alternate variations in arrangement and configuration are possible and included within the scope of the present invention. With reference to FIG. 2, the present vacuum pulse tool 4 is oriented on top of the MPE extraction well 6, with the inlet attached to either the well 6 or to a stinger pipe (not shown). The outlet of the vacuum pulse tool 4 is then connected to the inlet of the MPE vacuum pump 2. As the pump 2 exerts a vacuum on the entire treatment train, the vacuum pulse tool 4 is activated. The vacuum pulse tool 4 can either start simultaneously with the MPE vacuum, or it is also possible for the vacuum pulse tool to start after a period of continuous MPE vacuum pump operation. The present vacuum pulse tool 4 commences a sequence of very short term interruptions to the flow of vapour and liquids from the subsurface environment. The frequency of the interruptions is preferably adjusted to maximize the remedial effect during operation. In a most preferred embodiment, pulse frequency is in the order of from approximately 100 to 1000 pulses per minute, and will vary due to site-specific conditions.

The present vacuum pulse enhanced system can be used with recovery wells that are often screened in both the vadose zone 10 and into the aquifer 12. Optionally, a stinger pipe can be used inside of the recovery well and the relative elevation of the stinger pipe with regards to groundwater elevation can be adjusted during extraction to maximize vapour and liquid recovery.

The present vacuum pulse tool 4 is preferably designed as surface-mounted systems for standard injection wells or direct push injection points. However the present vacuum pulse tool 4 can optionally also be mounted to a variety of MPE configurations including a single pump, multiple pumps, multiple screened intervals and a variety of operational flow rates and vacuum levels. It is also possible to utilize the present vacuum pulse tool 4 on MPE systems configured with manifolding to multiple wells in a permanent or temporary design. Standard piping and fittings can be used to connect the present vacuum pulse tools 4 between the MPE vacuum pump 2 and the well 6.

It should be noted that incorporation of the present vacuum pulse technology with traditional MPE systems provides a number of important difference to pulsed MPE operation alone. When used in conjunction with the present vacuum pulse technology, the MPE can remain in continuous operational mode and does not require repeated shutdowns and re-starting. Instead the momentary interruptions are generated through the present vacuum pulse tool 4. These momentary interruptions and the resulting increased flow velocities are short-term events and do not interfere with MPE equipment operations. The present vacuum pulse technology acts to overcome previously seen levelling off of fluid flow rates with MPE operation alone, without the need to interrupt operation of the MPE system.

This detailed description of the present apparatus and methods is used to illustrate certain embodiments of the present invention. It will be apparent to a person skilled in the art that various modifications can be made in the present means and methods and that various alternate embodiments can be utilized without departing from the scope of the present application.

Having thus described the invention, what is claimed as new and secured by Letters Patent is:

1. A method for applying vacuum pulses to enhance multiphase vacuum extraction of vapours and liquids from contaminated subsurface wells, said method comprising:
a. initiating continuous multiphase vacuum extraction from the subsurface well;
b. imparting one or more short vacuum pulses to the subsurface environment to momentarily interrupt flow of vapours and liquids in the subsurface well;
c. allowing vacuum build up in the extraction apparatus; and
d. rapidly releasing vacuum build up to momentarily increase velocity of vapours and liquids being extracted from the subsurface well.

2. The method of claim 1, wherein steps b. to d. are repeated during continuous multiphase vacuum extraction.

3. The method of claim 1, for enhancing multiphase extraction of groundwater, wherein the short vacuum pulses impart increased energy to the groundwater pores to increase drainage and extraction.

4. The method of claim 1, for enhancing non-aqueous phase liquids recovery via multiphase extraction, wherein vacuum pulses impart increased energy to a non-aqueous phase liquid mass to increase drainage and extraction.

5. The method of claim 4, for enhancing light non-aqueous phase liquids recovery by multiphase extraction.

6. The method of claim 4, for enhancing dense non-aqueous phase liquids recovery by multiphase extraction.

7. The method of claim 1, wherein vacuum pulses are initiated simultaneously with initiation of continuous multiphase vacuum extraction.

8. The method of claim 1, wherein vacuum pulses are initiated following a predetermined period of continuous multiphase vacuum extraction.

9. The method of claim 1, wherein vacuum pulses are imparted at a frequency of from 100 to 1000 pulses per minute.

10. A device for imparting vacuum pulses to enhance multiphase extraction from contaminated subsurface wells, said device comprising:
a. a vacuum pulse tool having an inlet in fluid communication with the subsurface well and an outlet; and
b. one or more multiphase extraction vacuum pumps, connected to the outlet of the vacuum pulse tool.

11. The device of claim 10, wherein the vacuum pulse tool inlet is directly connected to the contaminated subsurface well.

12. The device of claim 10, wherein the vacuum pulse tool inlet is in fluid communication with the contaminated subsurface well via a stinger pipe, having an adjustable length.

13. The device of claim 10, wherein the vacuum pulse tool 4 is a surface-mounted system.

14. The device of claim 10, wherein the vacuum pulse tool is connected via a manifold to multiple contaminated subsurface wells in a permanent or temporary design.
